(19) United States
(12) Patent Application Publication
(10) Pub. No.: US 2015/0006283 A1
(43) Pub. Date: Jan. 1, 2015

(54) SYSTEM METHOD FOR ENHANCED MAILTO HYPERLINKS

(71) Applicant: @PAY IP HOLDINGS LLC, Wilmington, DE (US)

(72) Inventors: Isaiah Baca, Albuquerque, NM (US); James Kassemi, Albuquerque, NM (US); Dave Walz Burkett, Albuquerque, NM (US); Chad Person, Albuquerque, NM (US)

(73) Assignee: @PAY IP HOLDINGS LLC, Wilmington, DE (US)

(21) Appl. No.: 14/316,303

(22) Filed: Jun. 26, 2014

Related U.S. Application Data
(60) Provisional application No. 61/839,667, filed on Jun. 26, 2013.

(51) Int. Cl. G06F 17/22; G06Q 20/12; G06Q 30/02

(52) U.S. Cl. CPC G06F 17/2235; G06Q 30/0251; G06Q 20/12
USPC 705/14.49

(57) ABSTRACT

A method to enable transactions between a customer and a vendor that is facilitated by an e-commerce system, including generating an advertisement email campaign template and a list of target recipients; parsing the list of target recipients. Generating enhanced mailto hyperlinks that include a generic mailto hyperlink and an email client specific mailto hyperlink. Generating email advertisement messages based on the advertisement email campaign template, wherein each of the email advertisement messages includes at least one enhanced mailto hyperlinks, and wherein only one of the generic mailto hyperlinks or email client specific hyperlink can be displayed when the email advertisement message is opened. Transmitting the plurality of email advertisement messages to the list of target recipients.

### CROSS REFERENCE TO RELATED APPLICATION

This application claims the benefit of U.S. provisional application No. 61/839,667 filed Jun. 26, 2013, which is incorporated by reference as if fully set forth.

### FIELD OF INVENTION

The present invention is related to electronic payment systems.

### BACKGROUND

One of the assets of email-based e-commerce is the ubiquity of email access when online, and that possessing an email account is the foundation for people's online identities. Most online businesses and organizations require an email address as the basis for membership. Allowing users to access email, across a range of platforms and devices, has become a cornerstone of online and telecommunication services. However, wide expanse of access to email and the numerous formats in which email is viewed presents some basic challenges to any business reliant on unified viewing standards and consistent behavior of mailto hyperlinks in email advertising campaigns. A business wishing to facilitate monetary transactions that are contingent on predictable emails formats needs to implement a system designed to compensate for an email environment that is varied and discordant.

The online environment is increasingly dominated by users on mobile devices. Laptops, tablets, cell phones and in particular the smartphone represent the growing portion of the market place. Despite the particular popularity of any one device at a moment in time, a business cannot limit their reach to a single device, but must embrace the entire spectrum of devices made available to the consumer. The quality of a device's performance is often judged by whether the consumer may easily check their email accounts and if those accounts may be shared across all of the devices used by the consumer. Given a climate where a consumer may check email across a variety of types of devices, any system wishing to offer email-based monetary transactions needs include methodologies to compensate for the many variables produced by different devices when using mailto hyperlinks.

There are certain web-clients (particularly YAHOO and OUTLOOK) that do not offer good experiences with mailto hyperlinks because they will open the user's default mail client (OUTLOOK or APPLE's Mail) rather than staying within the web-client. This new client may not be configured with the same email address. This poses a problem for an e-commerce system that may process an email-based on the address. Switching clients is also not a welcome experience when responding to an email. This also complicates the intended two-click transaction, making it much less seamless. However, these clients have their own type of mailto hyperlinks that, when selected, provide the same functionality and will keep the user in the web-client's environment.

Although problems may arise in the receiving of emails, many of the causes of irregularities in emails may be traced back to the email service provider and the design of the email. These systems often have their own variables relating to graphic and mailto hyperlinks that affect an email-based transaction. A system that may integrate with multiple email service providers and create a consistent experience may be welcome in the marketplace. Providing vendors with the opportunity to generate their own code for their mailto hyperlinks that is easy to use even for the non-expert may be popular and permit a streamlined workflow for the designers.

### SUMMARY

A system and method are described in greater detail hereafter for maintaining consistent performance in the use of mailto hyperlinks in advertising emails. Based on documented history of performance, irregularities in emails may be associated with the clients, such as YAHOO, HOTMAIL or GMAIL. In particular a mailto hyperlink when selected may open an email in a client or program other than the web-based client the customer is using. The emails are coded with a template that may apply the standard mailto hyperlink used for email-based e-commerce transactions and a version of the mailto hyperlink that compensates for a specific client like YAHOO or OUTLOOK. The CSS of the email determines which link is used once the emails are viewed. If the end user is viewing mail in either OUTLOOK.com or YAHOO.com, the CSS rules may detect and display the proper version of the button. The system and method described herein comprises of a series of code templates designed to address specific issues associated with each problematic destinations. This design increases dependable function and of mailto hyperlinks and predictable viewing experience of advertising and fundraising emails.

These problematic destinations may be grouped by the domain of their email address. The system categorizes the email addresses associated with the vendor's list of recipients based on these issues and applies the appropriate template to that email group. This categorization is needed because only one client fix (alternative code template) may be applied to the standard email. These targeted mailto hyperlinks are often embedded behind graphic images of buttons.

This method and system described herein also comprises of a series of designs for tools that allow a vendor or the e-commerce system to generate their own code template for the mailto hyperlink button, (along with a token). This code may be copied directly into the code of the html of an advertising email when being designed in an email service provider such as MAILCHIMP or an application such as Dreamweaver, or it may be integrated into another system such as an email service provider. This process also includes generating the necessary token for an email-based financial transaction. This tool streamlines the process for the designer of an email advertisement, allowing them to design the graphics of the button and the code needed for the button in a single process and also keeping a more uniform and consistent experience for the end consumer once the mailto hyperlink is selected.

A method to enable transactions between a customer and a vendor that is facilitated by an e-commerce system are disclosed herein. The method including generating an advertisement email campaign template and a list of target recipients; parsing the list of target recipients. Generating enhanced mailto hyperlinks that include a generic mailto hyperlink and an email client specific mailto hyperlink. Generating email advertisement messages based on the advertisement email campaign template, wherein each of the email advertisement messages includes at least one enhanced mailto hyperlinks, and wherein only one of the generic mailto hyperlinks or email client specific hyperlink can be displayed when the email advertisement message is opened. Transmitting the plurality of email advertisement messages to the list of target recipients.

### BRIEF DESCRIPTION OF THE DRAWINGS

A more detailed understanding may be had from the following description, given by way of example in conjunction with the accompanying drawings wherein:

FIG. 1 shows an example system that may be used for enhanced mailto hyperlinks that may be used in e-commerce transactions;

FIG. 2 is a flow diagram of an example method that uses CSS class and ID targeting using CSS files;

FIG. 3 is a flow diagram for a method to facilitate coverage by the major browsers and modern clients;

FIG. 4 shows a transactional flow diagram of the example described in FIG. 3;

FIG. 5 is an example web page that shows a dashboard available to a vendor;

FIG. 6 is an example web page that shows a build email buttons webpage available to a vendor;

FIG. 7 is a transactional flow diagram of a method to begin a campaign to collect a donation, provide a service or sell a product; and

FIG. 8 is an example web page 800 that shows an account settings page available to a vendor.

### DETAILED DESCRIPTION

Email-based advertisements are useful ways for businesses and nonprofits to reach customers with information and product offers. They are also an excellent way to drive those customers to websites and online URL offers and checkouts using hyperlinks. Alternatively, the mailto-hyperlink, as disclosed in U.S. Pat. No. 8,772,263 entitled “Email based E-Commerce which is incorporated by reference in its entirety, provides the customer with an easy option for responding to an email advertisement with a message to an email address. For the consumer, the mailto hyperlink offers the convenience of generating an email message instantaneously with the address already in the correct field by only having to select a link in the email. The mailto hyperlink is less used than the URL hyperlink that drives a customer to a webpage, the mailto-hyperlink potential as a method for financial transactions is now only being realized with @Pay's Email Payment Gateway. In an environment where the mailto hyperlink is used for email-based e-commerce, the precise use of the mailto hyperlink and managing how it is used on the customers may be important.

When generating new emails using a mailto hyperlink, some web-clients such as YAHOO and OUTLOOK may open a user's default mail client (OUTLOOK or APPLE'S mail) rather than staying within the web-client. This new email may be configured with a different email address in the “from” field. Sending email from a different address may present a problem for an email-based e-commerce system that may process the email-based on the original email address. When creating email layouts, email clients (both web-based and non-web-based) may add an additional layer of issues that might arise depending where messages are viewed by the end user. An HTML-based email may be in a first format on OUTLOOK 2007 on a PC, and a second format when accessed from OUTLOOK.com on an APPLE OS computer. Further, it may be inoperable when viewed on the default client from an Android device. The standard email code may only work as desired on a fraction of available browsers. In other places a mailto hyperlink may not function as desired by opening a new browser based client, or the button graphic may not appear or may not work.

These issues may arise when web-clients require a specific type of mailto hyperlink that, when selected, provides the same functionality and may keep the user in the web-client's environment. The methods and apparatus described in greater detail hereafter allow for client specific mailto hyperlinks into a coded template included in the email message. Any single message may include a coded template that may provide a standard mailto hyperlink or an alternative web-client specific fix.

When used herein, the term “token” may refer a sequence of byte data or string or file used to authenticate a transaction. A token may be one or multiple encrypted strings, files, passwords, cyphers or other data which may contain information used to perform or authenticate a transaction when sent to e-commerce systems. These tokens may be encrypted using a public-private key encryption system. The vendor or a party with knowledge of the vendor's private key may generate an encrypted token. Alternatively, a payment system or e-commerce site may generate this token on behalf of the vendor. An email including the token may be sent by the e-commerce site, the vendor, or an email service provider.

Disclosed herein are processor-executable methods, computing systems, and related technologies for a vendor token generator for e-commerce transactions. The system and method may use an email server/account to complete checkout of any type of product (e.g., items/services/events/donations) for a transfer of funds from a customer to a vendor (e.g. retail site, charity, political organization or other vendor.) While the technologies described herein are described using email as an example, they may also be applicable to similar communication mediums, such as SMS and MMS communication channels.

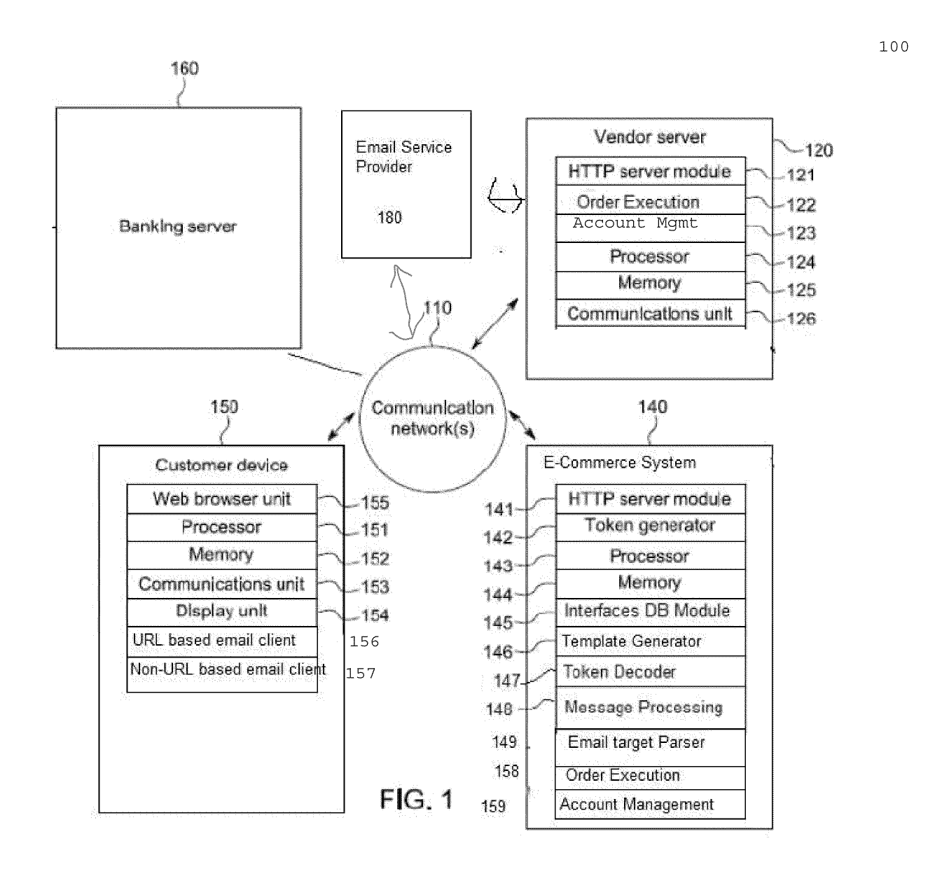

FIG. 1 shows an example system 100 that may be used for enhanced mailto hyperlinks that may be used in e-commerce transactions. The example system 100 includes a customer device 150, a vendor server 120, an e-commerce system 140, an email service provider 180, and a banking server 160 that may communicate over one or more wired and/or wireless communication networks 110. The wired or wireless communication networks 110 may be public, private or a combination of public or private networks.

The customer device 150 may be, for example, a cellular phone, a smartphone, a desktop computer, a laptop computer, a tablet computer, or any other appropriate computing device. The customer device 150 includes a processor 151, memory 152, a communications unit 153, a display unit 154, a web browser unit 155 that may communicate data to/from the web server module(s) in the vendor server 120 and e-commerce system 140, an URL based email client 156, and a non-URL based email client 157. The web browser unit 155 may include and/or communicate with one or more sub-modules that perform functionality such as rendering HTML (including but not limited to HTML5), rendering raster and/or vector graphics, executing JAVASCRIPT, and/or rendering multimedia content.

Alternatively or additionally, the web browser unit 155 may implement Rich Internet Application (RIA) and/or multimedia technologies such as ADOBE FLASH and/or other technologies compatible with Internet based communications. The web browser unit 155 may implement RIA and/or multimedia technologies using one or web browser plug-in modules (e.g., ADOBE FLASH), and/or using one or more sub-modules within the web browser unit 155 itself. The web browser unit 155 may display data on one or more display devices that are included in, or connected to, the customer device 150, such as a liquid crystal display (LCD) display or monitor. The customer device 150 may receive input from the user of the customer device 150 from input devices (not depicted) that are included in, or connected to, the customer device 150, such as a keyboard, a mouse, a microphone or a touch screen, and provide data that indicates the input to the web browser unit 155.

The vendor server 120 may include an HTTP server module 121, an order execution unit 122, an account management unit 123, a processor 124, memory 125, and a communications unit 126.

The HTTP server module 121 provides a website that may be accessed by a customer device 150. The HTTP server module 121 may implement the HTTP protocol, and may communicate Hypertext Markup Language (HTML) pages and related data from the website to/from the customer device 150 using HTTP. The vendor server 120 may be connected to one or more private or public networks (such as the Internet), via which the HTTP server module 121 communicates with devices such as the customer device 150. The HTTP server module 121 may generate one or more web pages and may communicate the web pages to the customer device 150, and may receive responsive information from the customer device 150.

The HTTP server module 121 may be, for example, an NGINX server, an APACHE HTTP server, a SUN-ONE Web Server, a MICROSOFT INTERNET Information Services (IIS) server, and/or may be based on any other appropriate HTTP server technology. The vendor server 120 may also include one or more additional components or modules (not depicted), such as one or more load balancers, firewall devices, routers, switches, and devices that handle power backup and data redundancy.

The order execution unit 122 is configured to receive instructions from received messages and executes orders on behalf of the vendor server 1220.

The account management unit 123 is configured to manage accounts registered with the vendor server 120. A customer, wishing to complete a transaction with a vendor server 120 may register his/her email address and payment information with the vendor server 120. The account management unit 123 may be configured to store a customer registry.

The memory 125 may be configured to store information associated with e-commerce transactions. This may include inventory information, information used to generate web pages, customer information, and other e-commerce data.

The communications unit 126 may be configured to transmit/receive communications via the communication network 110 or other inputs/outputs.

The e-commerce system 140 may include an HTTP server module 141, a token generator 142, a processor 143, memory 144, interfaces database module 145, template generator 146, token decoder 147, and a message processing unit 148. While only one vendor server 120 is shown communicating with the e-commerce system 140, this is shown as an example only. E-commerce system 140 may communicate with multiple vendor servers 120. Similarly, vendors may register with the e-commerce system 140. The e-commerce system 140 may provide the vendor server 120 with a public key and private key to be used in token transaction in accordance with the methods described herein. When a transaction is attempted (e.g. request to purchase goods, donate money), the e-commerce system 140 decodes the token, authenticates the sender of the email, which may allow the vendor server 120 to process the transaction. While the e-commerce system 140 is depicted as a separate entity in FIG. 1, this is shown as an example only. The e-commerce system 140 may be controlled and/or co-located with the vendor server 120, and/or the email service provider 180.

The token generator 142 may generate tokens for use in e-commerce transactions. Tokens may be encrypted strings which contain information to perform a transaction when sent to the e-commerce system(s) 140. A token may be one or multiple encrypted strings, files, passwords, cyphers or other data which may contain information used to perform or authenticate a transaction.

The email target parser 149 may receive a list of addresses of an email campaign. Based on the addresses of the recipients, the email target parser 149 may separate the email recipients into groups.

The template generator 146 may be configured to generate templates that may be used with different clients. The template generator 146 may generate specific templates, for example, for YAHOO, GMAIL, OUTLOOK, based clients etc. In one example, the template generator 146 may communicate with the email target parser 149 and transmit enhanced mailto hyperlinks that allow the recipients to be able to use the intended functionality of the mailto hyperlink.

The token decoder 147 may be configured to decode tokens received from external sources, such as a vendor server 120 or a customer device 150.

The message processing unit 148 is configured to analyze received messages and communicate with the token decoder 147 to determine if the received message is valid and to identify the request embedded in the message (e.g. request for purchase of goods.) If the token decoder 147 indicates the token is valid, the message processing unit 148 may then access the account management unit 159 to verify a transaction.

The account management unit 159 is configured to manage accounts registered with the e-commerce system 140. A customer or vendor, wishing to complete a transaction with an e-commerce system 140 may register his/her email address and payment information with the e-commerce system 140. The account management unit 159 may be configured to store a customer registry and vendor registry.

The interfaces database module 145 serves as an interface to databases associated with the e-commerce system 140.

The email service provider 180 may be associated with the vendor server 120, the e-commerce system 140, or may be a third party entity. The email service provider 180 may be configured to provide email marketing services. The email service provider 180 may further be configured to provide tracking information showing the status of email sent to each member of an address list. The email service provider 180 may further be configured to segment an address list into interest groups or categories to send targeted information. The email service provider 180 may also include an email parser or be connected to an external email parser, allowing parsing functions to be offloaded to the email service provider 180. The email service provider 180 may further be configured to create or use templates generated by the e-commerce system 140 for sending to contacts and/or the use of templates pre-made, email service provider 180 may include a user interface that allows a user to manually adjust the template or it may be integrated with external sources (e.g. vendor server 120 or e-commerce system 140). The email service provider 180 may comprise a send engine, which allows vendors to distribute their message to the customers. The email service provider 180 may be configured to customize dynamically the content of emails that are sent out, to tailor personalized information and mailto hyperlinks.

The banking server 160 may be controlled by a third party system bank. The e-commerce system 140 may communicate with the banking server 160 to verify that the customer has adequate funds or credit for the requested purchase. For example, the banking server 160 may be a controlled by VISA, AMERICAN EXPRESS, MASTERCARD or any other bank or banking or financial network that a customer may use for online payment. The banking server 160 may be a server for virtual currencies, such as BITCOIN, etc.

An email-based e-commerce system 140 may allow vendors to send advertising emails with a mailto-hyperlink associated with a specific product offer and select the mailto-hyperlink and generate a response email by selecting the mailto-hyperlink. This response email contains a token and is addressed to the e-commerce system 140. Once sent, this response email confirms the customer's purchase of the product by parsing the information in the token. The e-commerce system 140 processes the payment and notifies the vendor and the customer. The e-commerce system 140 may comprises a token generator, components for processing the tokens and a components for processing the payments and a system for notifying the vendor server 120 of the transaction details.

Referring back to the example system in FIG. 1, a payment processor (not pictured) may be an independent third party operated unit, it may be located in the e-commerce system 140 or the vendor server 120.

While the example system shown in FIG. 1 shows the e-commerce system 140 comprising the token generator 142, the token generator 142 this is shown as an example only. The vendor server 120 may also include a token generator that allows vendors to directly create tokens. In another example, a third party may have a token generator 142 to create tokens for use by the vendor server 120.

The methods and apparatus described in greater detail hereafter also allow the e-commerce system 140 to determine which version is applied. This may be performed using a Cascading Style Sheets (CSS). A CSS may be a style sheet language used for describing the look and formatting of an email written in a markup language, such as HTML. A web browser, client or email service provider 180 may be configured to use CSS to target predetermined classes and customer IDS in the web-client to determine the environment. CSS may be used to show which version of the mailto link may be used.

In another example, if CSS targeting fails, the e-commerce system 140 may be configured to generate targeted email campaigns based on the email address and include a customized mailto hyperlink. CSS and media queries may then be applied so that the initial mailto hyperlink is replaced with original mailto hyperlink on native clients. When the customer selects a mailto hyperlink, this may keep the customer within the same environment.

In one embodiment, the system may be configured to generate client specific mailto hyperlinks. Some web-based browsers (e.g. OUTLOOK.com and YAHOO.com) open mailto hyperlinks in the end-user's default email client (e.g. OUTLOOK 2007, APPLE Mail, or MOZILLA THUNDERBIRD). In this scenario, the e-commerce system 140 may receive a reply-email with a different email address than the email address associated with the mailto hyperlink. For example, if johndoe@yahoo.com clicks on a button with a mailto link while logged into his account in YAHOO's browser, instead of continuing the two-click process in yahoo.com, OUTLOOK 2007 (installed on his computer) opens. The process of the user being taken to a different browser, with potentially different configurations, may render mailto hyperlinks embedded within the email useless.

Different browsers have their own version of a mailto link in the form of an URL that will behave as desired, thus keeping the workflow within the environment. For example, using:
“http://compose.mail.yahoo.com/?to=TO&subject=SUBJECT&body=BODY”
   in an email being viewed in a YAHOO.com client, may open a new message within YAHOO.com, which may produce a desired result of keeping the customer in the same environment and using the same email address.

The methods and apparatus described herein use custom web-client mailto hyperlinks to display them only where applicable.

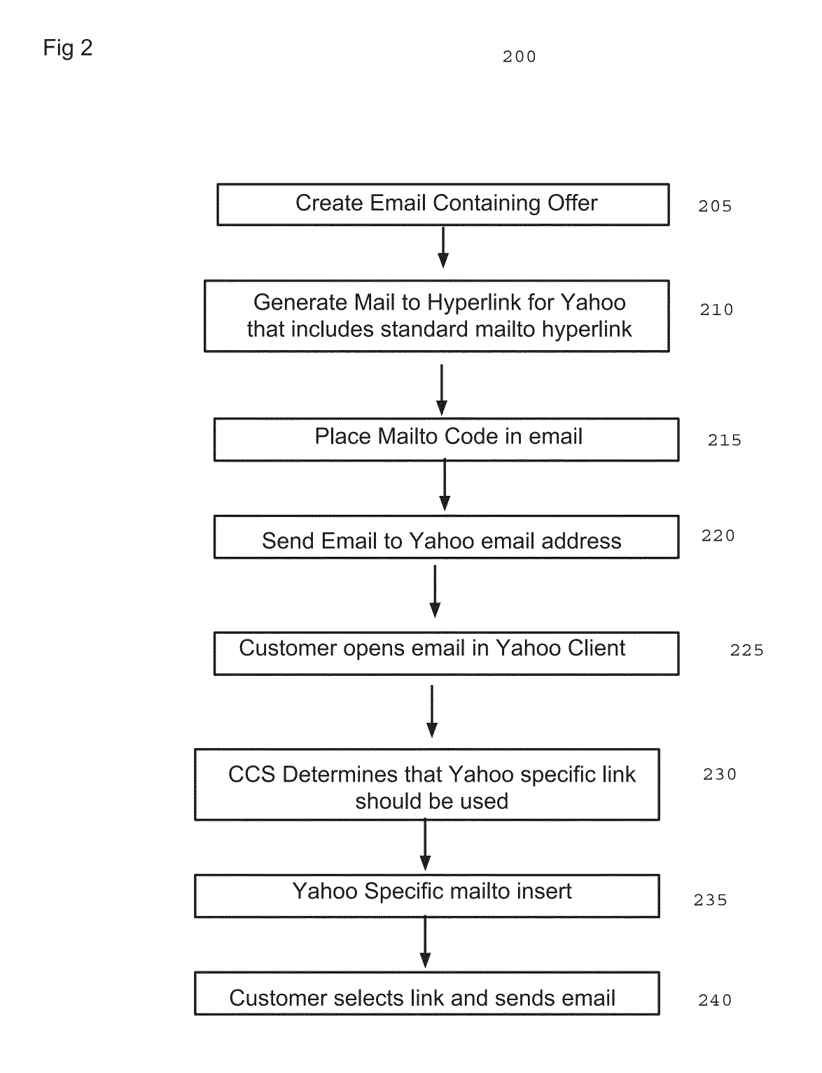

FIG. 2 is a flow diagram of an example method 200 that uses CSS class and ID targeting by reviewing CSS files, a specific CSS class or ID used may be identified by the browser. When the browser renders the HTML, those attributes may be used to hide and show elements (such as buttons). For example, Outlook has a unique “ExternalClass.” When this class is present a CSS rule is used to say to display the OUTLOOK mailto and, when not present, to hide any other mailto. This also permits other clients configured with this OUTLOOK email (such as an IPHONE) to display the correct button.

As shown in FIG. 2, an email offer is created (step 205). In this example, the email offer is directed to a customer with a YAHOO email address. The system generates an enhanced mailto hyperlink that includes a hyperlink for YAHOO and a standard mailto hyperlink (step 210). The code is inserted, for example, by an email service provider, into an HTML enabled email (step 215). This created a button in the email that may be accessed by the recipient. The email may then be sent to the customer with the yahoo email address (step 220). The customer may then open the email within their YAHOO client (step 225) (e.g. web based or app based.) When opening up the email, the CSS determines that because it is being opened up in a YAHOO client, that the yahoo specific mailto hyperlink should be used (step 230). The email client then displays the YAHOO specific mailto hyperlink is for access by the user, while hiding the standard mailto hyperlink (step 235). When the customer selects the mailto hyperlink embedded in the email, the automatically generated reply email is opened up within the YAHOO client. The customer may then send the automatically generated email (step 240).

The coded templates used to generate the client specific mailto hyperlinks may be configured to fix predetermined issues related to the specific client. Each client specific mailto hyperlink may be customized to that client requirement.

Some example issues associated with popular clients are described in Table 1 below.

TABLE 1

| Provider/Client | Issue | Solution |
|---|---|---|
| GMAIL | Does not allow style blocks. | Use inline |
| | | styles and |
| | | attributes |
| YAHOO/ | Mailto links have weird behavior | Use YAHOO |
| ROCKETMAIL/ | when images are reloaded. For | compose link |
| YMAIL | example the mailto would always | when buttons are |
| | open in the default browser, and | being viewed |
| | not in a YAHOO mail tab | in a YAHOO.com |
| OUTLOOK.com/ | Mailto links do not function | Use an |
| HOTMAIL/MSN/ | properly. For example with | OUTLOOK |
| LIVE MAIL | OUTLOOK.com they did not open | compose link |
| | anything at all. Standard mailto | instead of a |
| | links do not function whatsoever | regular mailto |

Some best practices may be useful across multiple platforms, for example: using inline styles and table layouts; inserting code that target=“blank” in all hrefs, and the simpler the button, the easier to apply targeting.

Another example may comprise a system designed for domain targeting. When sending a mailto link (i.e. a button) the system may detect whether the domain ends with YAHOO.com, for example, (or rocketmail.com or ymail.com). If so, the system attaches the YAHOO compose link. In this version of the system, the list is segmented into domain categories and each of the emails associated with a particular category is given the appropriate version(s) of the mailto hyperlinks.

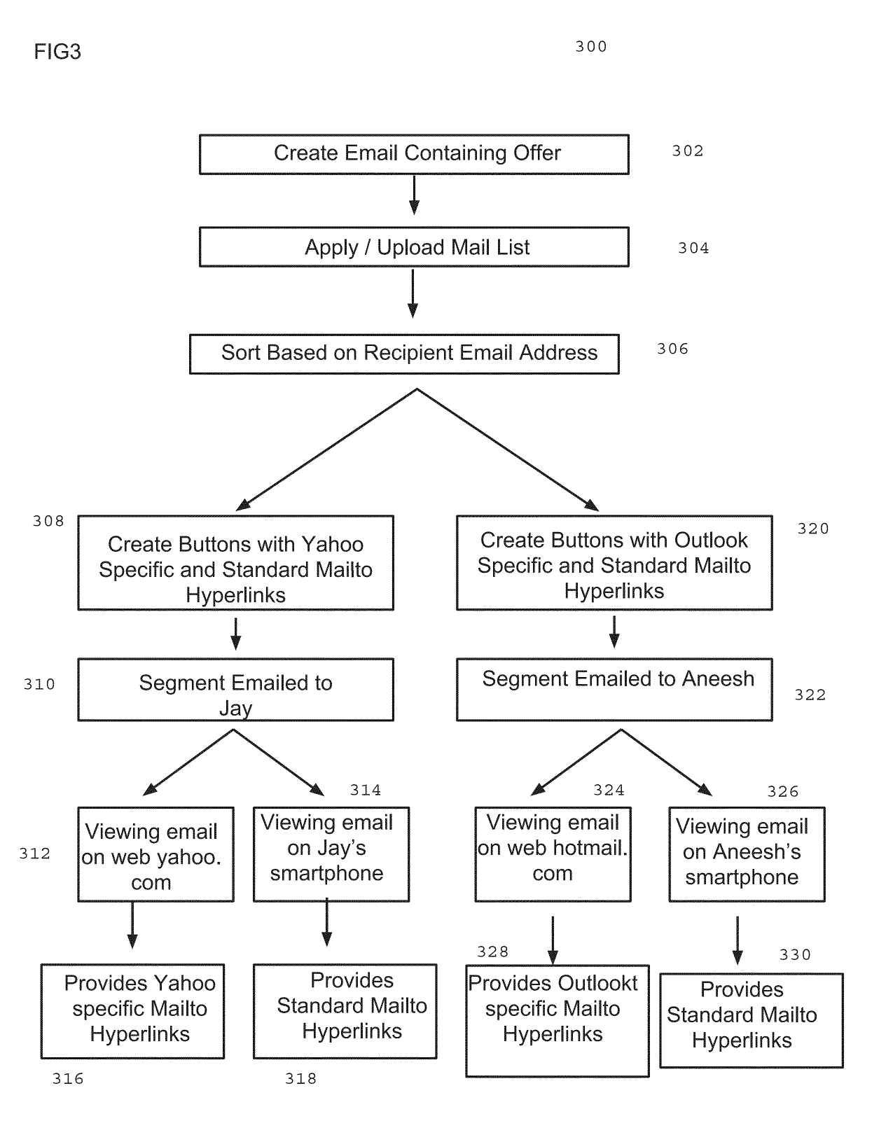

FIG. 3 is a flow diagram for a method 300 to facilitate coverage by the major browsers and modern clients. The vendor, seeking to create an email campaign may generate an email containing an offer (step 302). This offer may include an offer to buy products, a request for a donation, or other similar e-commerce transaction. The vendor may then upload or select a mailing list associated with the offer (step 304). The system, may then parse the mailing list based on the recipient email address (step 306). In the example shown in FIG. 3, there are only two recipients, but this is as an example only, the system described herein may be used for any number of email recipients. Similarly, in this example, while only two fixes are shown for YAHOO and OUTLOOK, the system may apply any number of fixes. Based on the email addresses, for users with a YAHOO.com email addresses, the system may generate buttons with both YAHOO specific and generic mailto hyperlinks (step 308). The YAHOO specific mailto hyperlink may include fixes needed to reply within the YAHOO client. The generic or standard mailto hyperlink may be a default mailto hyperlink that uses an html anchor (link) element with a “mailto” operand along with a token. For other email addresses, the system may generate buttons with OUTLOOK specific mailto hyperlinks and generic mailto hyperlinks (step 320). The system may apply appropriate CSS fixes to each of the templates. The system then uses domain targeting to determine which template to send to each particular email recipient, and sends the appropriate template (steps 310 and 322). The email message includes buttons that include the enhanced mailto hyperlinks. The first recipient (e.g. with a YAHOO.com domain email address) may receive the email message and open the message via a web browser on YAHOO.com (step 312) or may view the email on a smartphone (step 314). When the user selects a button embedded in the email message, to purchase an item, depending on the environment in which the email is open, a YAHOO specific mailto hyperlink may be opened or a standard mailto hyperlink may be opened, allowing the first recipient to remain in the same environment in which the email was opened. Similarly the second recipient receives an email message, they may view email via a web interface on hotmail.com domain or on a smartphone (steps 324 and 326). Depending on the environment in which they are viewing the email, when a button with an enhanced mailto hyperlink is selected, the device will open either an OUTLOOK specific mailto hyperlink or a standard mailto hyperlink (steps 328 and 330). Each email may include one or more enhanced mailto hyperlinks that may be associated with different products, services, quantities, or donation amounts.

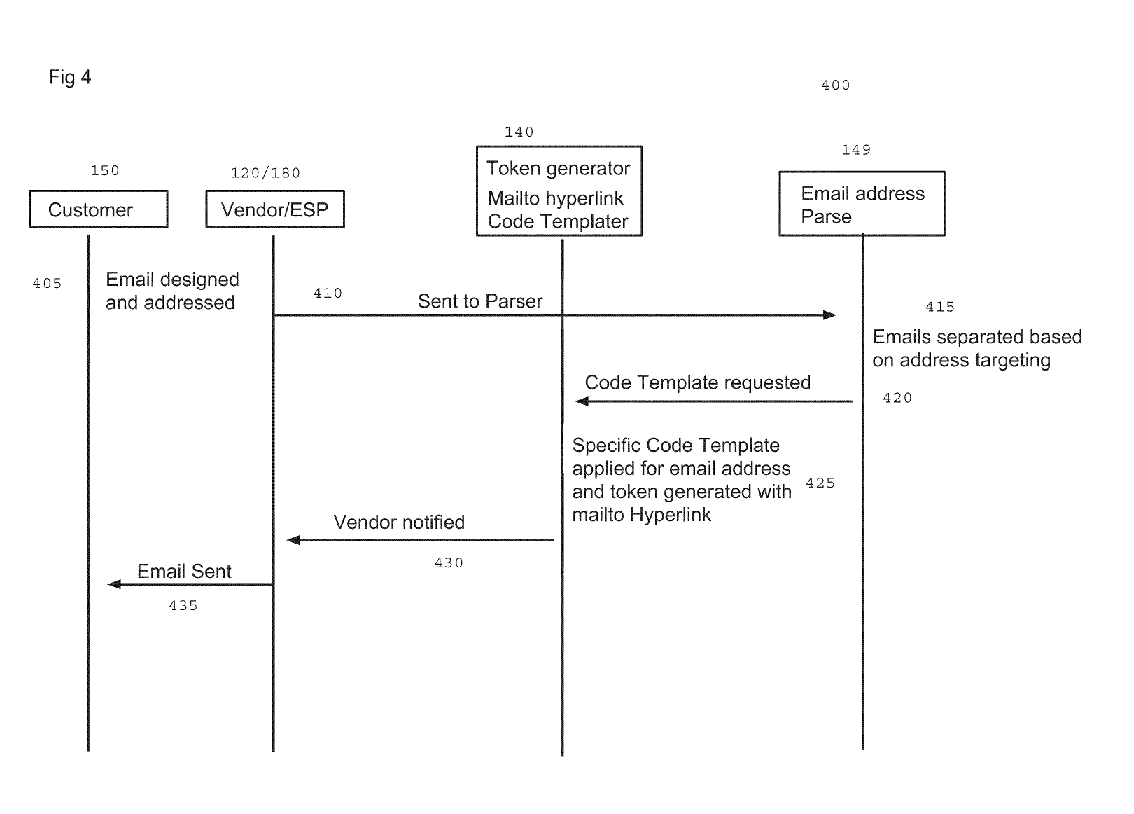

FIG. 4 shows a transactional flow diagram of the example described in FIG. 3. As shown in FIG. 4, the vendor server 120 and the email service provider 180 are co-located, but this is as an example only, they may be separate entities. Similarly, functionality for the token generator and mailto hyperlink code template generator are located on the e-commerce system and the email address parser is shown as an independent unit, however this is as an example only the functionalities may be split among the vendor server 120, the e-commerce system 140 and/or the email service provider 180. In this system the email list is segmented based on the domains in the email address. Each of these targeted emails are equipped with a coded template for both the standard link and the client specific version and it is the CSS that determines which is used. Because only one email may be composed of two templates, segmenting the email list is still necessary. However this allows for far less segmentation and all emails are equipped with a standard option. This will ensure coverage on all major browsers including, but not limited to, YAHOO.com, GMAIL.com, AOL.com, OUTLOOK.com (HOTMAIL.com, LIVE.com), iOS devices, ANDROID devices and YAHOO iOS devices.

Referring to FIG. 4, in a first step an email for an email campaign is designed and the recipient email addresses are entered (step 405). This information is sent to the email target parser 149 (step 410). The email target parser 149 separates the emails based on the email address of each of the recipients (step 415). The email target parser 149 requests a code template to use for each of the different domains associated with the recipients (step 420). A specific code template is generated for each email address and a token is generated with a mailto hyperlink that is associated with the token (step 425). The vendor is notified and provided information regarding the token and mailto hyperlink (step 430). The vendor server 120 or email service provider 180 may then integrate the enhanced mailto hyperlink tokens into the emails and send the emails out (step 435).

In some scenarios, a user may use a forwarding email address, in this case, where the domain name may be, e.g. a college alumni account that is forwarded to another email address. The account management unit 159 may be configured to store information regarding the final destination of an email and notify the token generator 142.

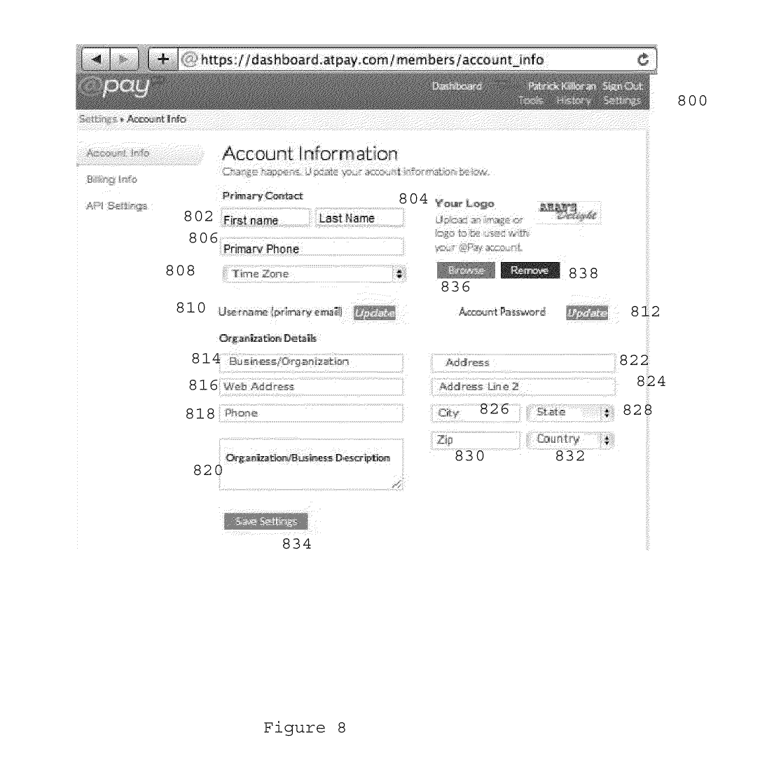

An e-commerce system 140, vendor server 120 or an email service provider 180 may implement all of the above fixes by integrating the system of segmenting their recipients by domains and sending the emails. The system may further include an interface that allows designers of emails to generate the graphic button with a mailto hyperlink and code required for validation for payment processing and the code template for the above fixes. This tool may be integrated in several locations, the vendor server 120, e-commerce system 140 or the email service provider 180. A single email may have multiple mailto hyperlinks included. Making a button generator accessible to a designer may streamline the process to distribute an email campaign. This may also create a standard method for generating the appropriate code and a graphic button. In this scenario, the vendor server 120 may register an account with the e-commerce system 140, as shown in FIG. 8 below, to access the tool that generates the mailto hyperlinks with the required token for validation for payment processing. In this example, payment processing is performed by the e-commerce system 140 and transaction information is accessible on their personal account page.

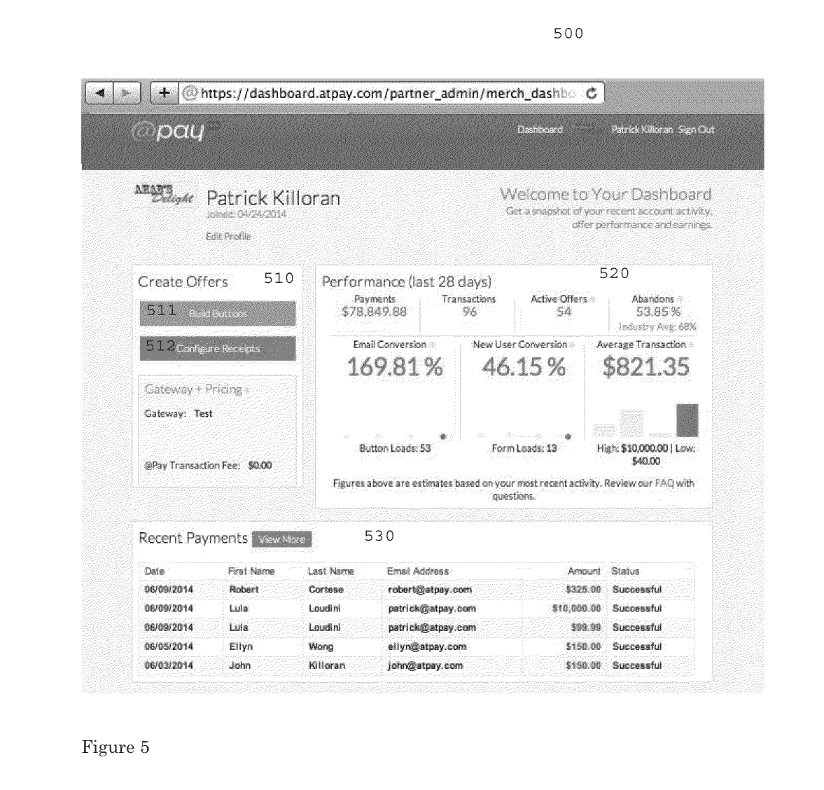

FIGS. 5, 6, and 8 show example web pages that may be displayed by the web browser unit 155. As will be described in detail below, the web pages may include display elements which prompt the user of the customer device 150 for information to generate email campaigns. The web pages may be included in a web browser window that is displayed and managed by the web browser unit 155. The web pages may include data received by the web browser unit 155 from the vendor server 120, the e-commerce system 140 or any other web server.

For smaller organizations the button generation system may remain part of the e-commerce system 140 where the organization may access this feature of the e-commerce system 140 to generate the code and then copy that code into an advertising email's HTML. For larger organizations, there may be a preference to duplicate the e-commerce system's 140 button generation capabilities or access it programmatically via the API.

FIG. 5 is an example web page 500 that shows a dashboard available to a vendor. As shown in FIG. 5, the web page 500 may multiple fields 510-530 that provide information, and multiple input buttons 511 and 512.

As shown in FIG. 5, the user can track the transactions initiated by the mailto hyperlink buttons that are included in previous email campaigns through field 520. The user may also track recent payments using the information provided in field 530. If the user wishes to build buttons, the user may select input button 511. If the user wishes to configure receipts to be delivered to customers in response to payment processing of an email campaign the user may select input button 512. As the user selects an input button 511-512, the web browser unit 155 may store one or more data structures (“response data”) that reflect the selections made in the input buttons 511-512. Further, as the selections are updated, the web browser unit 155 may update the web page 500 to indicate additional or more specific questions that may be associated with the selections.

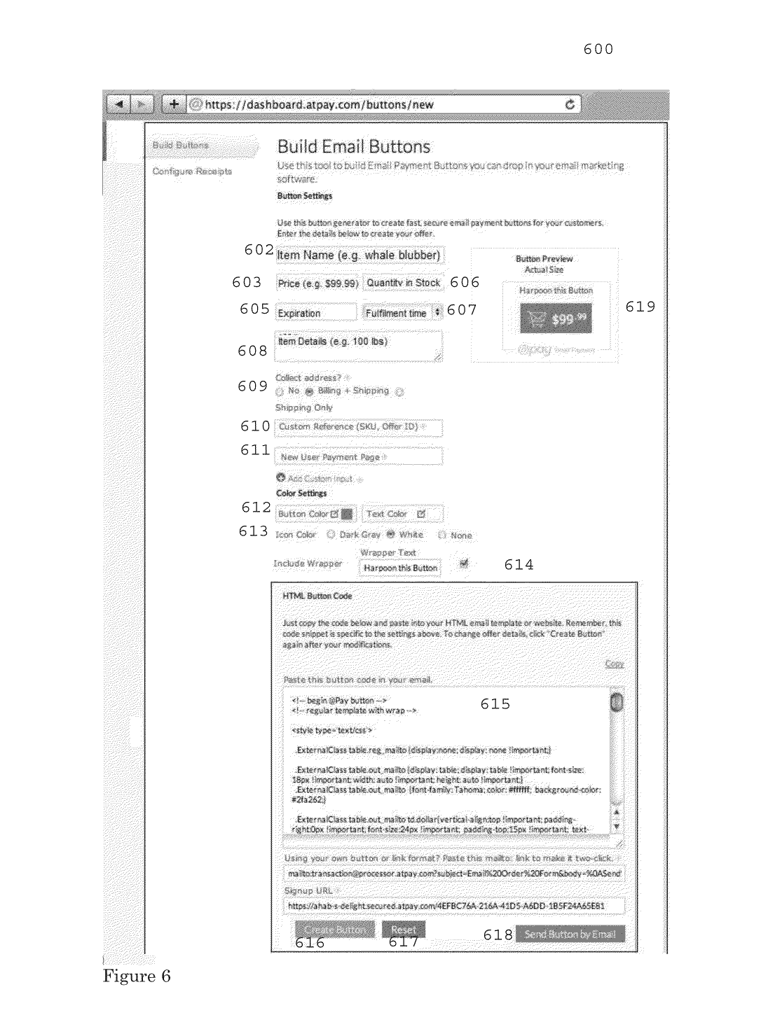

FIG. 6 is an example web page 600 that shows a build email buttons webpage available to a vendor. As shown in FIG. 6, the web page 500 may multiple input fields 602-618 that solicit information that may be used to generate a button for use in email-based e-commerce. On this page they may input the specific about the product, delivery time and its cost, etc. They may also design specify color of the button and view a preview. Because the number of digits vary in the text space for the price, the length of the button changes based on the number of digits required by the vendor. The button's scale automatically adjusts based on the number of digits entered. The designer may also choose to include additional “wrapper text” that frames the button. This is an opportunity to add a message or draw attention to the button. The wrapper text component may also carry product information such as a description, quantity, size and might vary in scale. These components and process may be stored for later access in an index (inventory). Additionally this index may integrate with an inventory program automatically generating an index of accessible buttons for all of the vendor's products or the system may integrate directly into an inventory held by the vendor. This inventory may also be generated by uploading spreadsheets.

As shown in FIG. 6, the user is asked for information regarding the appearance and use of the button. As the user enters information into input fields 602-619, the web browser unit 155 may store one or more data structures (“response data”) that reflect the selections made in the input fields 602-619. Further, as the selections are updated, the web browser unit 155 may update the web page 500 to indicate additional or more specific questions that may be associated with the selections. As shown in FIG. 6, a user is requested to enter an item name 602, item price 603, quantity in stock 606, expiration date of the offer 605, projected fulfillment time for the offer 607, and any additional item details 608.

The user is also requested as to which addresses to collect 609, any custom reference number associated with the offer 610, or whether to direct the user to a new user payment page 611. The user may also select the color settings of the button using input fields 612-614.

Preview field 619 provides the user with a preview of what the button looks like based on the information provided in fields 602-614. If the user accepts this preview, they may select input field 616 to generate a button. If the user does not accept the preview, they may select input field 617 and reset the process. The user may then send a button by email, by selecting input field 618, or copy text from field 615 and paste it in an email manually.

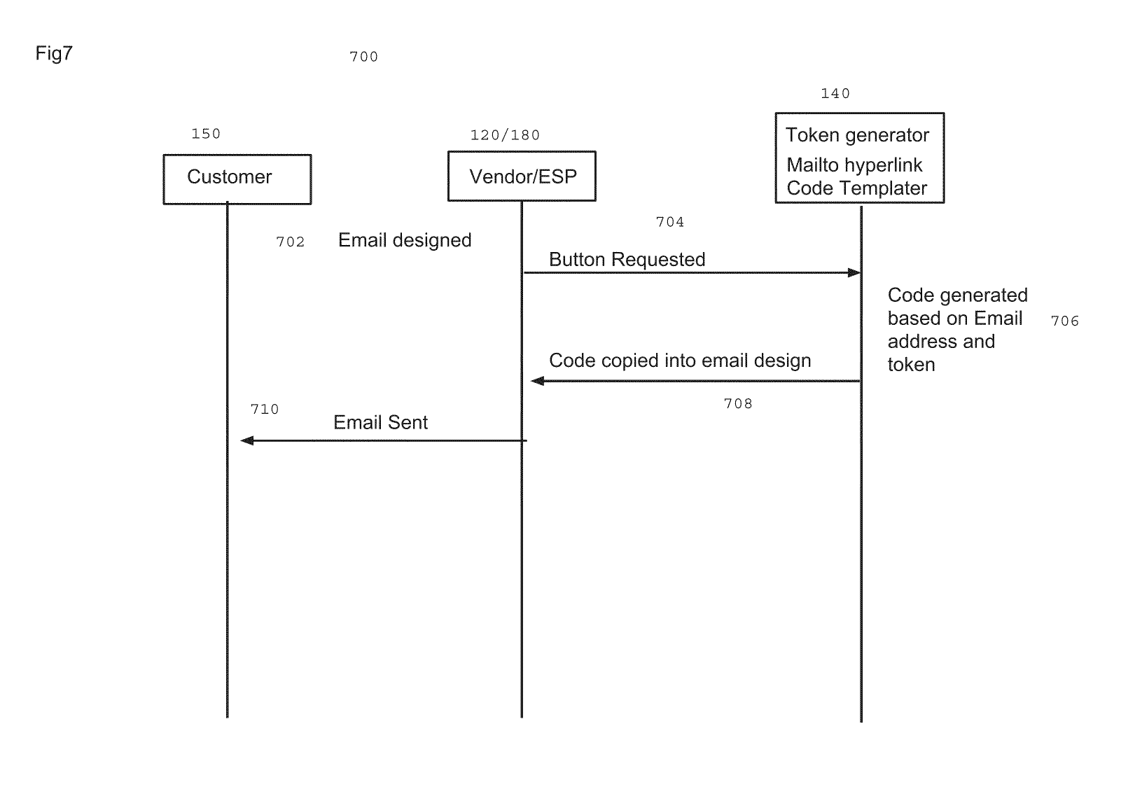

FIG. 7 is a transactional flow diagram of a method to begin a campaign to collect a donation, provide a service or sell a product. The vendor designs an email using an email service provider 180 or using email program (step 702). The vendor may then wish to insert an email-based payment button. To insert the button, the vendor logs into an account with the e-commerce system 140 and view the dashboard, as shown in FIG. 5. Through the dashboard, the vendor may check account information, check their transaction history, configure their receipts and generate code for their buttons. The vendor may use the build email buttons webpage or they may request to build email buttons programmatically by the API. Once all the product information is entered the user requests a button (step 704) this generates the code for the button (step 706) which may appear in a web page, for example as shown in FIG. 6. The vendor may access a version of the code to be pasted into the code of their email in the next window there is code if they are using their own button design and at the bottom there is a window a URL link that provides a URL checkout and sign up. This is the link which is also used to sign up a customer if they are not yet registered for the email payment gateway. The designer may copy this code and paste it directly into the html of their advertising email (step 708). After the email is sent and the customer has made a purchase the transaction information may be viewed on the dashboard under recent payments (step 710). Receipts may also be managed and designed from this account for example, by accessing webpage 500 and selecting input button 512.

In another example of the system the email advertisements may be sent out automatically based on triggers of customer behaviors. For example a customer may purchase a baby blanket and the system offers the customer a deal on baby pacifiers. In this example, the system may include an index of inventory that is placed automatically into emails.

FIG. 8 is an example web page 800 that shows an account settings page available to a vendor. As shown in FIG. 8, a user may enter primary contact information, including name, phone number, time zone, username and password, in input fields 802-812. The user may further enter organization details, including business name, web address, business phone number, a description of the business, and address of the business in input fields 822-832. The user may upload a logo or avatar to be used in connection with their account using input field 836 or they may remove their logo by selecting input field 838. Once the user has entered/updated the settings, the user may select input field 834 and save the settings. As the user enters information in input fields 802-838, the web browser unit 155 may store one or more data structures (“response data”) that reflect the selections made in the input fields 802-838. Further, as the selections are updated, the web browser unit 155 may update the web page 800 to indicate additional or more specific questions that may be associated with the input.

The methods and apparatus described herein may be applicable to a number of applications wherein a mailing list is parsed, an enhanced hyperlink is generated based on the email addresses associated with the mailing list. When the email is received and the user may be presented with either a general or specific mailto hyperlink.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BLURAY-Disc, or other type of device for electronic data storage.

Although the methods and features described above with reference to FIGS. 2-8 are described above as performed using the example system 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-8 may be used alone without the other features and elements or in various combinations with or without other features and elements. Sub-elements of the methods and features described above with reference to FIGS. 1-8 may be performed in any arbitrary order (including concurrently), in any combination or sub-combination.

What is claimed is:

1. A method to enable transactions between a customer and a vendor that is facilitated by an e-commerce system, the method comprising:
generating an advertisement email campaign template and a list of target recipients;
parsing the list of target recipients, based at least on the respective email addresses associated with the list of target recipients, to determine email clients associated with the list of target recipients;
generating a plurality of enhanced mailto hyperlinks, wherein the enhanced mailto hyperlinks include a generic mailto hyperlink and an email client specific mailto hyperlink, wherein the email client specific mailto hyperlink is based at least in part on the determined email clients associated with the list of target recipients, wherein the generic mailto hyperlink and the email client specific mailto hyperlink each include a token;
generating a plurality of email advertisement messages based on the advertisement email campaign template, wherein each of the plurality of email advertisement messages includes at least one of the plurality of enhanced mailto hyperlinks, and wherein only one of the generic mailto hyperlinks or email client specific hyperlink can be displayed when the email advertisement message is opened; and
transmitting the plurality of email advertisement messages to the list of target recipients.

2. The method of claim 1, further wherein the email client specific mailto hyperlink is a GMAIL specific mailto hyperlink.

3. The method of claim 1, further wherein the email client specific mailto hyperlink is a YAHOO specific mailto hyperlink.

4. The method of claim 1, further wherein the email client specific mailto hyperlink is an OUTLOOK specific mailto hyperlink.

5. The method of claim 1, wherein the enhanced mailto hyperlink includes cascading style sheets (CSS) coding.

6. The method of claim 1, wherein the enhanced mailto hyperlink includes at least two email client specific mailto hyperlinks.

7. The method of claim 1, further comprising:
receiving a reply email, in response to at least one of the a plurality of email advertisement messages; and
processing an order based on the received reply email.

8. The method of claim 1, wherein each of the plurality of email advertisement messages includes a plurality of enhanced mailto hyperlinks, wherein each of the plurality of enhanced mailto hyperlinks within an email advertisement message may be associated with a different product.

9. A system to enable transactions between a customer and a vendor that is facilitated by an e-commerce system, the system comprising:
a processor configured to generate an advertisement email campaign template and a list of target recipients;
an email parser configured to parse the list of target recipients, based at least on the respective email addresses associated with the list of target recipients, to determine email clients associated with the list of target recipients;
a token generator configured to generate a plurality of enhanced mailto hyperlinks, wherein the enhanced mailto hyperlinks include a generic mailto hyperlink and an email client specific mailto hyperlink, wherein the email client specific mailto hyperlink is based at least in part on the determined email clients associated with the list of target recipients, wherein the generic mailto hyperlink and the email client specific mailto hyperlink each include a token;
the processor configured to generate a plurality of email advertisement messages based on the advertisement email campaign template, wherein each of the plurality of email advertisement messages includes at least one of the plurality of enhanced mailto hyperlinks, and wherein only one of the generic mailto hyperlinks or email client specific hyperlink can be displayed when the email advertisement message is opened; and
a transmitter configured to transmit the plurality of email advertisement messages to the list of target recipients.

10. The system of claim 9, further wherein the email client specific mailto hyperlink is a GMAIL specific mailto hyperlink.

11. The system of claim 9, further wherein the email client specific mailto hyperlink is a YAHOO specific mailto hyperlink.

12. The system of claim 9, further wherein the email client specific mailto hyperlink is an OUTLOOK specific mailto hyperlink.

13. The system of claim 9, wherein the enhanced mailto hyperlink includes cascading style sheets (CSS) coding.

14. The system of claim 9, wherein the enhanced mailto hyperlink includes at least two email client specific mailto hyperlinks.

15. The system of claim 9, further comprising:
a receiver configured to receive a reply email, in response to at least one of the a plurality of email advertisement messages; and
the processor configured to process an order based on the received reply email.

16. The system of claim 9, wherein each of the plurality of email advertisement messages includes a plurality of enhanced mailto hyperlinks, wherein each of the plurality of enhanced mailto hyperlinks within an email advertisement message may be associated with a different product.
